(19) United States
(12) Patent Application Publication
(10) Pub. No.: US 2021/0082298 A1
(43) Pub. Date: Mar. 18, 2021

(54) Sliding Reminder Board Apparatus

(71) Applicant: Dale Birdsell, Tacoma, WA (US)

(72) Inventor: Dale Birdsell, Tacoma, WA (US)

(21) Appl. No.: 16/574,835

(22) Filed: Sep. 18, 2019

(51) Int. Cl. G09B 1/06

(52) U.S. Cl. CPC G09B 1/06

(57) ABSTRACT

A sliding reminder board apparatus for reminding and tracking tasks and chores includes a board body and a plurality of tracks coupled to the board body. Each track comprises a top rail and a parallel bottom rail coupled to a board front side and defining a status area therebetween. A plurality of status indicator pairs is coupled to the status area of one of the tracks. Each status indicator pair has an incomplete sign and a complete sign coupled to a left half and a right half of the status area, respectively. Each of a plurality of plastic sleeves is slidably engageable within the tracks to cover either the left half or the right half of the status area. Each of a plurality of task cards is selectively coupled within one of the plastic sleeves and displays a task name to be performed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

The disclosure relates to reminder devices and more particularly pertains to a new reminder device for reminding and tracking tasks and chores.

### (2) Description of Related Art including information disclosed under 37 CFR 1.97 and 1.98.

The prior art relates to reminder devices.

### BRIEF SUMMARY OF THE INVENTION

An embodiment of the disclosure meets the needs presented above by generally comprising a board body having a board front side, a board back side, a board top side, a board bottom side, a board left side, and a board right side. A plurality of tracks is coupled to the board body. Each track comprises a top rail and a parallel bottom rail coupled to the board front side. The top rail and the bottom rail define a status area of the board front side therebetween. A plurality of status indicator pairs is coupled to the board body. Each status indicator pair is coupled to the status area of one of the tracks. Each status indicator pair has an incomplete sign and a complete sign coupled to a left half and a right half of the status area, respectively. A plurality of plastic sleeves each has an open sleeve end and is slidably engageable within the tracks to cover either the left half or the right half of the status area. Each of a plurality of task cards is selectively coupled within one of the plastic sleeves through the open sleeve end. Each task card displays a task name to be performed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front elevation view of a sliding reminder board apparatus according to an embodiment of the disclosure.

FIG. 2 is an in-use view of an embodiment of the disclosure.

FIG. 3 is an isometric view of an embodiment of the disclosure.

FIG. 4 is a rear elevation view of an embodiment of the disclosure.

### DETAILED DESCRIPTION OF THE INVENTION

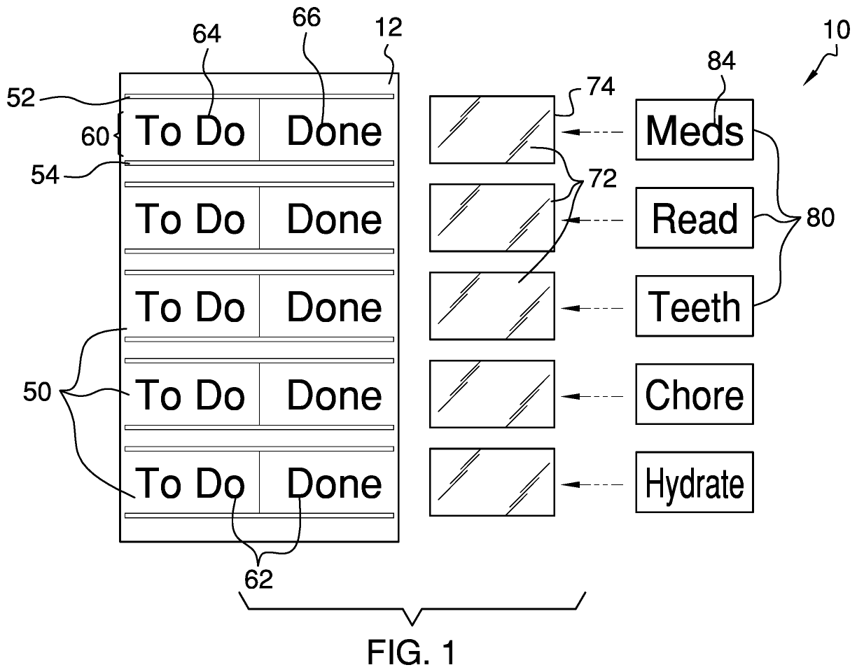

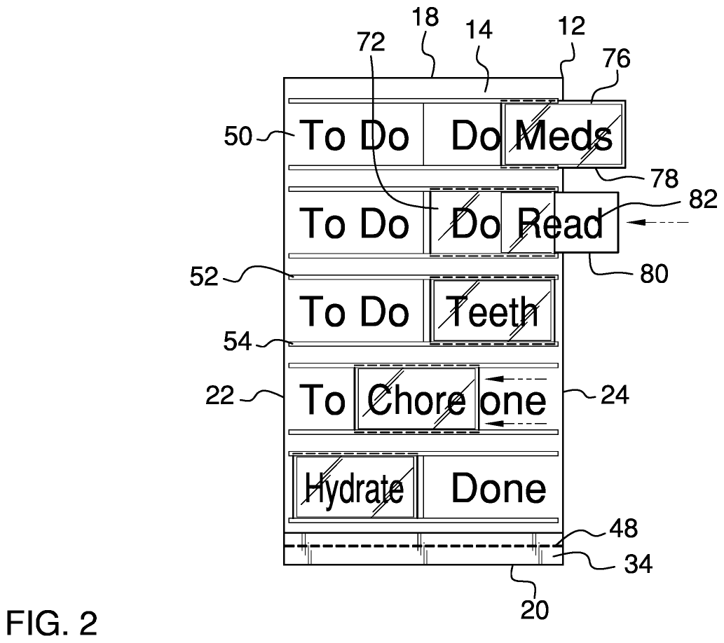

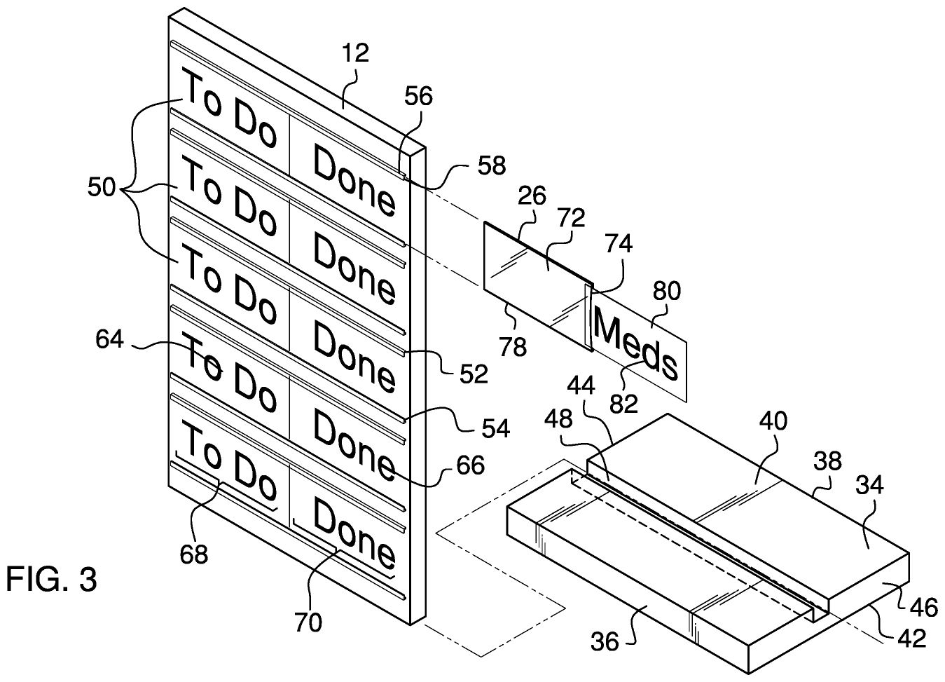

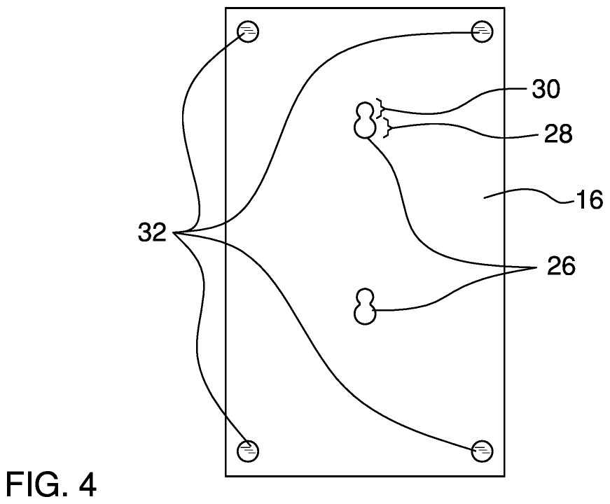

With reference now to the drawings, and in particular to FIGS. 1 through 4 thereof, a new reminder device embodying the principles and concepts of an embodiment of the disclosure and generally designated by the reference numeral 10 will be described.

As best illustrated in FIGS. 1 through 4, the sliding reminder board apparatus 10 generally comprises a board body 12 having a board front side 14, a board back side 16, a board top side 18, a board bottom side 20, a board left side 22, and a board right side 24. The board back side 16 may have at least one wall hook slot 26, each having a larger lower portion 28 configured to receive a head of a fastener and a smaller upper portion 30 configured to secure the fastener. The wall hook slots 26 may be a pair of a wall hook slots 26 aligned along a medial axis of the board back side 16. A plurality of mounting members 32 may be coupled to the board back side 16. The mounting members 32 may be magnets or other mounting members such as hook-and-loop fasteners, pins, adhesives, and the like. The plurality of mounting members 32 is configured to secure the board body 12 to a surface such as, but not limited to, a wall, a whiteboard, a bulletin board, and the like. A base 34 has a base front side 36, a base back side 38, a base top side 40, a base bottom side 42, a base left side 44, and a base right side 46. The base top side 40 has a board slot 48 extending from the base left side 44 through the base right side 46. The board slot 48 selectively receives the board bottom side 20 to support the board body 12.

A plurality of tracks 50 is coupled to the board body 12. Each track 50 comprises a top rail 52 and a parallel bottom rail 54 coupled to the board front side 14 and extending from proximal the board left side 22 to proximal the board right side 24. Each top rail 52 and each bottom rail 54 may have a perpendicular portion 56 extending from the board front side 14 and parallel portion 58 extending from the perpendicular portion 56. The top rail 52 and the bottom rail 54 define a status area 60 of the board front side therebetween. A plurality of status indicator pairs 62 is coupled to the board body 12 within the status area 60 of one of the tracks. Each status indicator pair 62 has an incomplete sign 64 and a complete sign 66 coupled to a left half 68 and a right half 70 of the status area, respectively. The incomplete sign 64 may read “To Do” and the complete sign 66 may read “Done”.

Each of a plurality of plastic sleeves 72 has an open sleeve end 74 and is slidably engageable within the tracks 50 to cover either the left half 68 or the right half 70 of the status area. An upper edge 76 and a lower edge 78 of each sleeve 72 is held within the parallel portion 58 of the top rail 52 and the bottom rail 54, respectively. Each of a plurality of task cards 80 is selectively coupled within one of the plastic sleeves 72 through the open sleeve end 74. Each task card 80 displays a task name 82 to be performed. The task name 82 may be preprinted or handwritten on the task card 80. The task name 82 may be, but is not limited to, “Meds”, “Read”, “Teeth”, “Chore”, and “Hydrate”.

In use, the desired task cards 80 are inserted into the plastic sleeves 72 which are then slid into the tracks 50. The task cards 80 are positioned to cover the complete sign 66 so the apparatus 10 displays the incomplete sign 64 and then the task name 82, for example “To Do Meds” to remind the user to take medication. Once complete, the relevant sleeve 72 holding the task card 80 is slid to cover the incomplete sign 64 to display the task name 82 and the complete sign 66, for example “Meds Done”.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A sliding reminder board apparatus comprising:
a board body, the board body having a board front side, a board back side, a board top side, a board bottom side, a board left side, and a board right side;
a plurality of tracks coupled to the board body, each track comprising a top rail and a parallel bottom rail coupled to the board front side, the top rail and the bottom rail defining a status area of the board front side therebetween;
a plurality of status indicator pairs coupled to the board body, each status indicator pair being coupled to the status area of one of the tracks, each status indicator pair having an incomplete sign and a complete sign coupled to a left half and a right half of the status area, respectively;
a plurality of plastic sleeves, each plastic sleeve having an open sleeve end, each plastic sleeve being slidably engageable within the tracks to cover either the left half or the right half of the status area; and
a plurality of task cards, each task card being selectively coupled within one of the plastic sleeves through the open sleeve end, each task card displaying a task name to be performed.

2. The sliding reminder board apparatus of claim 1 further comprising a base, the base having a base front side, a base back side, a base top side, a base bottom side, a base left side, and a base right side, the base top side having a board slot extending from the base left side through the base right side, the board slot selectively receiving the board bottom side to support the board body.

3. The sliding reminder board apparatus of claim 1 further comprising the board back side having at least one wall hook slot, each hook slot having a larger lower portion configured to receive a head of a fastener and a smaller upper portion configured to secure the fastener.

4. The sliding reminder board apparatus of claim 3 further comprising a plurality of mounting members coupled to the board back side, the plurality of mounting members being configured to secure the board body to a surface.

5. The sliding reminder board apparatus of claim 1 further comprising the plurality of tracks being five tracks.

6. The sliding reminder board apparatus of claim 1 further comprising each top rail and each bottom rail extending from proximal the board left side to proximal the board right side.

7. The sliding reminder board apparatus of claim 1 further comprising each top rail and each bottom rail having a perpendicular portion extending from the board front side and parallel portion extending from the perpendicular portion.

8. A sliding reminder board apparatus comprising:
a board body, the board body having a board front side, a board back side, a board top side, a board bottom side, a board left side, and a board right side, the board back side having at least one wall hook slot, each hook slot having a larger lower portion configured to receive a head of a fastener and a smaller upper portion configured to secure the fastener;
a plurality of mounting members coupled to the board back side, the plurality of mounting members being configured to secure the board body to a surface
a base, the base having a base front side, a base back side, a base top side, a base bottom side, a base left side, and a base right side, the base top side having a board slot extending from the base left side through the base right side, the board slot selectively receiving the board bottom side to support the board body;
a plurality of tracks coupled to the board body, each track comprising a top rail and a parallel bottom rail coupled to the board front side and extending from proximal the board left side to proximal the board right side, each top rail and each bottom rail having a perpendicular portion extending from the board front side and parallel portion extending from the perpendicular portion, the top rail and the bottom rail defining a status area of the board front side therebetween;
a plurality of status indicator pairs coupled to the board body, each status indicator pair being coupled to the status area of one of the tracks, each status indicator pair having an incomplete sign and a complete sign coupled to a left half and a right half of the status area, respectively;
a plurality of plastic sleeves, each plastic sleeve having an open sleeve end, each plastic sleeve being slidably engageable within the tracks to cover either the left half or the right half of the status area; and
a plurality of task cards, each task card being selectively coupled within one of the plastic sleeves through the open sleeve end, each task card displaying a task name to be performed.
